(19) United States
(12) Patent Application Publication
(10) Pub. No.: US 2025/0165974 A1
(43) Pub. Date: May 22, 2025

(54) SYSTEMS AND METHODS FOR AUTHENTICATED, PRIVATE, AND AUDITABLE ACTIONS IN EMAILS AND OTHER MESSAGING APPS

(71) Applicant: Cyphlens LLC, Albany, NY (US)

(72) Inventors: Andrea G. Forte, Brooklyn, NY (US); Rocky Motwani, New York, NY (US)

(73) Assignee: Cyphlens LLC, Albany, NY (US)

(21) Appl. No.: 18/515,294

(22) Filed: Nov. 21, 2023

(51) Int. Cl. G06Q 20/40; G06Q 20/38

(52) U.S. Cl. CPC G06Q 20/4014; G06Q 20/38215

(57) ABSTRACT

An authorization system is disclosed for data verification and approval in communication platforms. The system includes a workflow engine comprising one or more processors and at least one memory element for storing instructions. The workflow engine retains client identifiers associated with communication content. A client device, in communication with the workflow engine. The communication platform receives communication content generated by a computer system and encrypted by the workflow engine. The encrypted communication content is visually encoded as an authentication image and displayed within the communication platform. An electronic device, also in communication with the workflow engine, includes an authentication identifier reader. The reader decrypts the client identifier from the authentication image, and the decrypted client identifier is validated by the workflow engine to authenticate the intended user. Authenticated communication content is displayed on the client device, and authorization for access to the communication content is transmitted to the workflow engine.

### FIELD

This invention relates to secure communication and authorization systems, and in particular to systems and methods for transaction verification and approval in communication and messaging platforms.

### BACKGROUND

Previous approaches to data verification and approval in communication platforms have typically relied on traditional authentication methods such as manually entering usernames and passwords at a third-party site. These methods often require users to manually enter their credentials, which may be time-consuming and prone to human error. Additionally, these approaches may not provide a secure and efficient means of verifying the authenticity of communication content. Some existing systems have attempted to address these issues by implementing encryption techniques. These systems encrypt the communication content to ensure its confidentiality during transmission. However, these encryption methods do not provide a comprehensive solution for data verification and approval in communication platforms. In summary, previous approaches to data verification and approval in communication platforms have utilized traditional authentication methods, encryption techniques, and authentication images. However, none of these approaches have provided a comprehensive solution that combines the features described in this disclosure.

In various common scenarios, such as payments, and in Internet applications like e-commerce shopping carts, individuals and entities often need to acknowledge, verify, authorize, or take action on specific information and transactions. Typically, this is done through interactions on a website, mobile app, or specialized device like a point-of-sale terminal. It may also occur via messaging channels like email, SMS, or other messaging apps.

However, the current method for taking such action through email, SMS, or messaging apps is limited. It usually involves either replying or forwarding the message, or clicking on a hyperlink which redirects the user to another web or mobile application where they need to log in to complete the action.

Replying to an email (or similar actions in SMS or messaging apps) comes with certain risks and limitations. For instance, if a user's email account is compromised, a hacker may take action on the email without the user's knowledge. Additionally, the integrity of the email's content, including any attachments, cannot be guaranteed. This means either the legitimate user or a hacker could manipulate the data, potentially leading to misrepresentation of the sender's intent. In such cases, it may be challenging for the sender or recipient to detect that the email's content has been tampered with. Moreover, the data sent is vulnerable to immediate or future unauthorized access and misuse, making it inadvisable for including sensitive information in the initial reply (e.g., CVV card verification value for credit card payments).

Clicking on a hyperlink in an email to perform an action in another application also has its drawbacks. Email hyperlinks are susceptible to phishing attacks and/or downloading malicious software onto a user's device without their consent (i.e., malicious links), causing users to hesitate before clicking on a link that takes them out of their email application. Furthermore, if an email account has been compromised, the hacker can click on the hyperlink and execute the action (e.g., click a password reset link and reset the password). Additionally, after clicking the link, users often need to re-authenticate themselves on the external application or website before proceeding with the intended action. This process may be less secure, cumbersome, and provide a sub-optimal user experience.

In the current market, most email applications, particularly those designed for enterprise use, include a read-receipt feature. When a user opens an email, the sender of the email receives a notification indicating that the email has been “read” by the recipient. It's important to note that this read-receipt feature is passive, meaning it merely signifies that the email has been accessed, and it doesn't necessarily confirm that the intended recipient has personally viewed it. In fact, in some cases, anyone with access to the email account (not specifically the intended recipient) may trigger this notification. Additionally, a user may sometimes mark an email as “read” by interacting with a Ul element (like a flag), which in turn triggers the read-receipt, without actually opening the email. Therefore, relying solely on the read-receipt notification for active confirmation that an email has been genuinely opened, let alone read, may not always be accurate.

Currently, merchants disseminate offers to potential and existing customers through text messages or emails for the purchase of goods and services. These offers typically encompass: 1) coupons and/or discounts for specific goods or services; 2) advertisements highlighting special prices for certain goods or services. To redeem these offers, users usually follow one of two methods: a) clicking on a hyperlink that redirects them from their messaging or email application to the merchant's website or app; or b) receiving a code in the email or text that they may use when visiting the retailer or service provider's website or physical location, be it a digital or brick-and-mortar storefront. However, these methods have their drawbacks. In a first example of uncontrolled sharing, the method is susceptible to misuse as hyperlinks and codes may be accessed by anyone possessing them, making it challenging for the merchant to restrict the offer to specific recipients or a limited number of recipients. In an example of their static nature, many if these offers remain fixed (e.g., offer expiration, pricing, or discount level), and altering the offer necessitates sending a new email. In an example of limited data privacy, many methods do not afford the merchant any data privacy, as the information in the email is transmitted in plain text and may be forwarded to any email address, potentially allowing competitors to view and react to the offers being extended. In an example of limited personalization, due to the constraints outlined in the aforementioned examples, merchants are compelled to create broad-market offers that lack personalization for individual recipients. In the example for a non-secure Redemption process, many of these methods lack a reliable means of confirming whether a prospective customer has redeemed the offer directly from their email, unless they include a hyperlink for the user to click on or the user responds directly to the email (both approaches are unreliable and susceptible to misuse by an authorized user with access to such emails, even if forwarded).

Concerning the verification of information, most email applications do not provide a mechanism for recipients to confirm the accuracy of the information received in an email. While users may respond to an email to convey that they believe the information to be accurate, this approach is unreliable, susceptible to misuse by authorized users in the event of email account compromise (e.g., unauthorized approval, data leakage), and susceptible to alterations of the information contained in the email. The same challenges persist when the information is attached to the email rather than included in the email body. Alternatively, users may be directed, often through hyperlinks but not exclusively, to another application or website where they must undergo a re-authentication process to access, review, and validate the received information. For instance, on a monthly basis, banks dispatch emails to inform customers that their statements are available for examination to ensure accuracy. Users exit their email application and navigate to the bank's website to verify their financial transactions and statements. Another scenario involves the confirmation of a user's bank account details for a payment. In such cases, users usually need to either call their bank (or receive a call from them) or visit another application or website, typically belonging to the bank, to validate their bank account and routing number.

In regards to granting approval for information, there is currently no established method for recipients of emails, text messages, or other forms of messaging to directly grant approval from within these platforms. Although users may respond to an email with text expressing their desire to approve certain information, this approach is deemed unreliable, vulnerable to misuse by unauthorized individuals, susceptible to phishing attacks, results in a high degree of friction, and is generally considered unsuitable for most approval processes. Alternatively, users are redirected, typically through hyperlinks but not exclusively, from their email application to an external application or website where they may initiate, resume, or complete the approval procedure.

In regards to authorizing payments and purchases, currently, individuals receiving emails, text messages, or other forms of communication lack a direct means to authorize payments or purchases from within these platforms. While users may respond to an email with a message indicating their intention to proceed with a purchase, this approach is deemed unreliable, susceptible to unauthorized use, and unsuitable for transactions involving monetary value. As an alternative, users are directed (usually through hyperlinks, but not exclusively) to another application or website where they may complete the purchase of goods or services via a payment transaction. Typically, the website to which the user is redirected is the same one where the purchase process was initiated. While this approach improves the user experience by providing a payment link, for example, it still lacks a comprehensive system for authorization and access control.

None of the art described above addresses all of the issues that the present invention does.

### SUMMARY

An authorization system is disclosed for data verification and approval in communication platforms. The system includes a workflow engine comprising one or more processors and at least one memory element for storing instructions. The workflow engine retains client identifiers associated with communication content. A client device, in communication with the workflow engine, includes processors, memory element, display, and a communication platform with a user interface. The communication platform receives communication content generated by a computer system and encrypted by the workflow engine. The encrypted communication content is visually encoded as an authentication image and displayed within the communication platform. An electronic device, also in communication with the workflow engine, includes a display, processors, memory element, and an authentication identifier reader. The reader decrypts the client identifier from the authentication image, and the decrypted client identifier is validated by the workflow engine to authenticate the intended user. Authenticated communication content is displayed on the client device, and authorization for access to the communication content is transmitted to the workflow engine and which also includes improvements that overcome the limitations of prior art authorization systems are now met by a new, useful, and non-obvious invention.

In some aspects, the techniques described herein relate to an authorization system for data verification and approval in communication platforms, including: a workflow engine including: one or more processors; and at least one memory element, at least one memory element configured to store instructions for controlling the one or more processors, the at least one memory element retains one or more client identifiers associated with communication content; a client device, the client device is in communication with the workflow engine over a network. The client device, including: one or more processors; at least one memory element, the at least one memory element configured to store instructions for controlling the one or more processors; a display; and a communication platform having a user interface, the communication platform of the client device is configured to receive the communication content by a computer system, the computer system having a client identifier of the one or more client identifiers to identify an intended user at which the communication content is created, the communication content is configured to be generated by the computer system and encrypted by the workflow engine. Responsive to encryption, encrypted communication content is visually encoded as an authentication image, the authentication image is displayed within the communication platform of the client device.

The electronic device is in communication with the workflow engine over the network. The electronic device, includes: a display having a graphical user interface; one or more processors; at least one memory element, the at least one memory element stores the client identifier of the computer system; and an authentication identifier reader. The authentication identifier reader is configured to decrypt the client identifier from the authentication image when the authentication identifier reader identifies the authentication image, wherein responsive to decryption, a decrypted client identifier is configured to be validated, by the workflow engine, to authenticate the intended user. Authenticated decrypted communication content is configured to be displayed on the display of the client device to the authenticated intended user, and an authorization for access to the communication content of the communication platform is configured to be transmitted, by the electronic device, to the workflow engine.

In some aspects, the techniques described herein relate to an authorization system for data verification and approval in communication platforms, wherein the authentication image is configured to indicate to a sender of the communication content, when at least a portion of the communication content has been accessed by the authenticated intended user.

In some aspects, the techniques described herein relate to an authorization system for data verification and approval in communication platforms, wherein the communication content is configured to be altered in real-time by a sender of the communication content, and wherein the altered communication content is configured to be displayed on the communication platform of the client device when the authenticated intended user decrypts the authentication image.

In some aspects, the techniques described herein relate to an authorization system for data verification and approval in communication platforms, wherein the encrypted client identifier having encrypted content.

In some aspects, the techniques described herein relate to an authorization system for data verification and approval in communication platforms, wherein the authentication image is a visual representation of the communication content.

In some aspects, the techniques described herein relate to an authorization system for data verification and approval in communication platforms, wherein the electronic device having a camera, the camera is configured to capture the authentication image of the display of the client device.

In some aspects, the techniques described herein relate to an authorization system for data verification and approval in communication platforms, wherein the authentication image of the display of the client device is uploaded to the electronic device.

In some aspects, the techniques described herein relate to an authorization system for data verification and approval in communication platforms, wherein the client identifier is at least one of a username, an email address, or a name of a user.

In some aspects, the techniques described herein relate to an authorization system for data verification and approval in communication platforms, wherein the electronic device having an input sensor disposed on the display of the electronic device, the input sensor configured to sense an external input to submit the authorization for access to the communication content, to the workflow engine.

In some aspects, the techniques described herein relate to an authorization system for data verification and approval in communication platforms, wherein the authorization for the access to the communication content is transmitted to the workflow engine when the client identifier of the electronic device matches the client identifier associated with communication content of the workflow engine.

In some aspects, the techniques described herein relate to an authorization system for data verification and approval in communication platforms, wherein the authenticated decrypted communication content is configured to be altered by the authenticated intended user.

In some aspects, the techniques described herein relate to an authorization system for data verification and approval in communication platforms, wherein the authenticated decrypted communication content is configured to be authorized sequentially by one or more authenticated intended users.

In some aspects, the techniques described herein relate to an authorization system for data verification and approval in communication platforms, wherein the authenticated decrypted communication content is configured to be authorized in parallel by one or more authenticated intended users.

In some aspects, the techniques described herein relate to an authorization system for data verification and approval in communication platforms, further including a financial transaction system, the financial transaction system in communication with the workflow engine and the authenticated decrypted communication content, and wherein the authenticated decrypted communication content being a payment request.

In some aspects, the techniques described herein relate to an authorization system for data verification and approval in communication platforms, wherein the authenticated decrypted communication content is configured to be altered by the authenticated intended user.

In some aspects, the techniques described herein relate to an authorization system for data verification and approval in communication platforms, including: a workflow engine including: one or more processors; and at least one memory element, the at least one memory element configured to store instructions for controlling the one or more processors, the at least one memory element retains one or more client identifiers associated with communication content; and an electronic device, the electronic device is in communication with the workflow engine over a network, the electronic device, including: one or more processors; at least one memory element, the at least one memory element configured to store instructions for controlling the one or more processors; a display; and a communication platform having a user interface, the communication platform of the client device is configured to receive the communication content by a computer system, the computer system having a client identifier of the one or more client identifiers to identify an intended user at which the communication content is created, the communication content is configured to be generated by the computer system and encrypted by the workflow engine, and wherein responsive to encryption, encrypted communication content is visually encoded as an authentication image, the authentication image is displayed within the communication platform of the electronic device; and an authentication identifier reader, the authentication identifier reader is configured to decrypt the client identifier from the authentication image when the authentication identifier reader identifies the authentication image, and wherein responsive to decryption, a decrypted client identifier is configured to be validated, by the workflow engine, to authenticate the intended user, and wherein authenticated decrypted communication content is configured to be displayed on the display of the electronic device to the authenticated intended user, and an authorization for access to the communication content of the communication platform is configured to be transmitted, by the electronic device, to the workflow engine.

In some aspects, the techniques described herein relate to a method for data verification and approval in communication platforms, including: generating, by a computer system, communication content having a client identifier to identify an intended user; encrypting, by a workflow engine, the communication content; responsive to encryption, encrypted communication content is visually encoded as an authentication image; displaying the authentication image within the communication platform, using a display of an electronic device; decrypting the client identifier from the authentication image, using an authentication identifier reader, when the authentication identifier reader identifies the authentication image, responsive to decryption, validating a decrypted client identifier, by the workflow engine, to authenticate the intended user, displaying authenticated decrypted communication content on the display of the electronic device to the authenticated intended user; and transmitting an authorization for access to the communication content of the communication platform, by the electronic device, to the workflow engine.

In some aspects, the techniques described herein relate to a method for data verification and approval in communication platforms, further including altering, by the authenticated intended user, the authenticated decrypted communication content.

In some aspects, the techniques described herein relate to a method for data verification and approval in communication platforms, further including altering the communication content in real-time, by a sender of the communication content, and wherein displaying the altered communication content on the communication platform of the electronic device when the authenticated intended user decrypts the authentication image.

In some aspects, the techniques described herein relate to a method for data verification and approval in communication platforms, further including transmitting the authorization for the access to the communication content to the workflow engine when the client identifier of the electronic device matches the client identifier associated with the communication content of the workflow engine.

### BRIEF DESCRIPTION OF THE DRAWINGS

The present disclosure may be better understood and its numerous features and advantages made apparent to those skilled n the art by referencing the accompanying drawings. The use of the same reference symbols in different drawings indicates similar or identical items.

FIG. 1 is a block diagram illustrating an authorization system, according to some embodiments of the present disclosure.

FIG. 2 is a block diagram illustrating an authorization system, according to some embodiments of the present disclosure.

FIG. 3 is a flowchart illustrating a method, according to some embodiments of the present disclosure.

FIG. 4 is a flowchart further illustrating the method from FIG. 3, according to some embodiments of the present disclosure.

### DETAILED DESCRIPTION

Example embodiments of the present invention will now be described with reference to the drawings. These embodiments are provided by way of explanation of the present invention, which is not intended to be limited thereto. In fact, those of ordinary skill in the art may appreciate upon reading the present specification and viewing the present drawings that various modifications and variations may be made thereto.

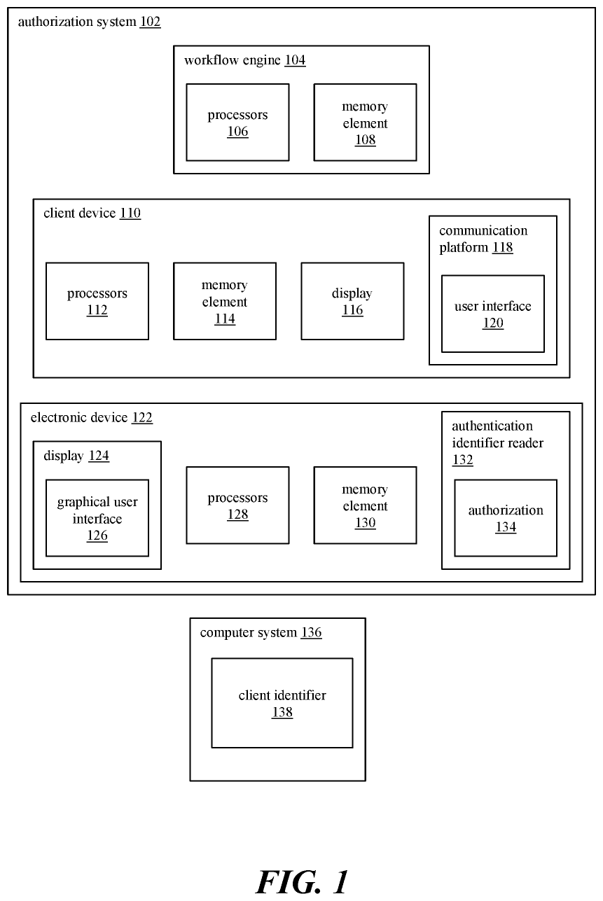

FIGS. 1-4 illustrate example methods and systems for secure communication and authorization systems for authentication and authorization processes as well as for transaction verification and approval. A technological infrastructure or platform is designed to facilitate safe and protected exchange of information between different entities and/or systems. It also includes elements that ensure that only authorized users and/or entities have access to certain functionalities or data within the system. In such a system, secure communication includes the use of encryption protocols and/or other security measures to safeguard data during transmission. Authorization components, on the other hand, involve mechanisms for verifying the identity of users or systems and granting them specific permissions or privileges based on their credentials.

In an example, the system may be configured for a user to perform actions including, but not limited to, acknowledging, verifying, approving, and/or authorizing information and/or transactions directly within communication and messaging platforms such as an email application, SMS, and/or messaging application in a secure and efficient manner. Cyphlens images (i.e., a visual encoding of encrypted content) offer a solution within email applications, allowing users to carry out actions like acknowledging, claiming, verifying, approving, or authorizing information and transactions. This approach mitigates the risks and usability concerns discussed earlier. With Cyphlens, users may take action directly from their email application without being redirected to a different platform, enhancing the overall security of the process.

At its core, a Cyphlens image sent through an email application is resistant to modification or tampering by unauthorized individuals. It provides protection against compromised email accounts, ensuring that only the intended recipient may decrypt and act upon it. Any unauthorized individual with access to the user's email account would be unable to decrypt the Cyphlens image and proceed with any action. Additionally, Cyphlens maintains the integrity of the encrypted content, preventing any unauthorized manipulation or alteration. The following examples illustrate how Cyphlens empowers users to perform various actions directly within their email application, SMS, or other messaging app.

FIG. 1 is a block diagram that describes an authorization system 102, according to some embodiments of the present disclosure. In some embodiments, the authorization system 102 may include a workflow engine 104. The authorization system 102 may also include a client device 110, the client device 110 may be in communication with the workflow engine 104 over a network. The authorization system 102 may also include an electronic device 122, the electronic device 122 may be in communication with the workflow engine 104 over the network.

In some embodiments, the workflow engine 104 may include one or more processors 106. The workflow engine 104 may also include at least one memory element 108, the at least one memory element 108 configured to store instructions for controlling the one or more processors 106. The at least one memory element 108 retains one or more client identifiers associated with communication content. The client device 110 may include one or more processors 112, a display 116, and a communication platform 118. The client device 110 may also include at least one memory element 114, the at least one memory element 114 configured to store instructions for controlling the one or more processors 112.

In some embodiments, the communication platform 118 may also include a user interface 120, the communication platform 118 of the client device 110 may be configured to receive the communication content including, but not limited to, an email, and/or a message, to name a few, by a computer system 136. The electronic device 122 may include a display 124 and one or more processors 128. The electronic device 122 may also include at least one memory element 130, the at least one memory element stores the client identifier 138 of the computer system 136. The electronic device 122 may also include an authentication identifier reader 132, the authentication identifier reader 132 may be configured to decrypt the client identifier 138 from the authentication image when the authentication identifier reader 132 identifies the authentication image.

In some embodiments, the display 124 may include a graphical user interface 126. The authentication identifier reader 132 may also include an authorization 134 for access to the communication content of the communication platform 118 may be configured to be transmitted, by the electronic device 122, to the workflow engine 104. Responsive to decryption, a decrypted client identifier may be configured to be validated, by the workflow engine 104, to authenticate the intended user.

In some embodiments, authenticated decrypted communication content may be configured to be displayed on the display 124 of the client device 110 to the authenticated intended user. The computer system 136 may also include a client identifier 138 of the one or more client identifiers to identify an intended user at which the communication content may be created, the communication content may be configured to be generated by the computer system 136 and encrypted by the workflow engine 104. Responsive to encryption, encrypted communication content may be visually encoded as an authentication image, the authentication image may be displayed within the communication platform 118 of the client device 110.

In some embodiments, the authentication image may be configured to indicate to a sender of the communication content, when at least a portion of the communication content. Been accessed by the authenticated intended user. In some embodiments, the communication content may be configured to be altered in real-time by a sender of the communication content. The altered communication content may be configured to be displayed on the communication platform 118 of the client device 110 when the authenticated intended user may decrypt the authentication image.

In some embodiments, the encrypted client identifier may include encrypted content. In some embodiments, the authentication image may be a visual representation of the communication content. In some embodiments, the electronic device 122 may also include a camera, the camera may be configured to capture the authentication image of the display 124 of the client device 110. In some embodiments, the authentication image of the display 124 of the client device 110 may be uploaded to the electronic device 122.

In some embodiments, the client identifier 138 may be at least one of a username, an email address, or a name of a user. In some embodiments, the electronic device 122 may also include an input sensor disposed on the display 124 of the electronic device 122, the input sensor configured to sense an external input to submit the authorization 134 for access to the communication content, by the workflow engine 104.

In some embodiments, the authorization 134 for the access to the communication content may be transmitted to the workflow engine 104 when the client identifier 138 of the electronic device 122 may match the client identifier 138 associated with communication content of the workflow engine 104. In some embodiments, the authenticated decrypted communication content may be configured to be altered by the authenticated intended user.

In some embodiments, the authenticated decrypted communication content may be configured to be authorized sequentially by one or more authenticated intended users. In some embodiments, the authenticated decrypted communication content may be configured to be authorized in parallel by one or more authenticated intended users. In some embodiments, the authorization system 102 for data verification and approval in communication platforms. The authenticated decrypted communication content may be a payment request. In some embodiments, the authenticated decrypted communication content may be configured to be altered by the authenticated intended user.

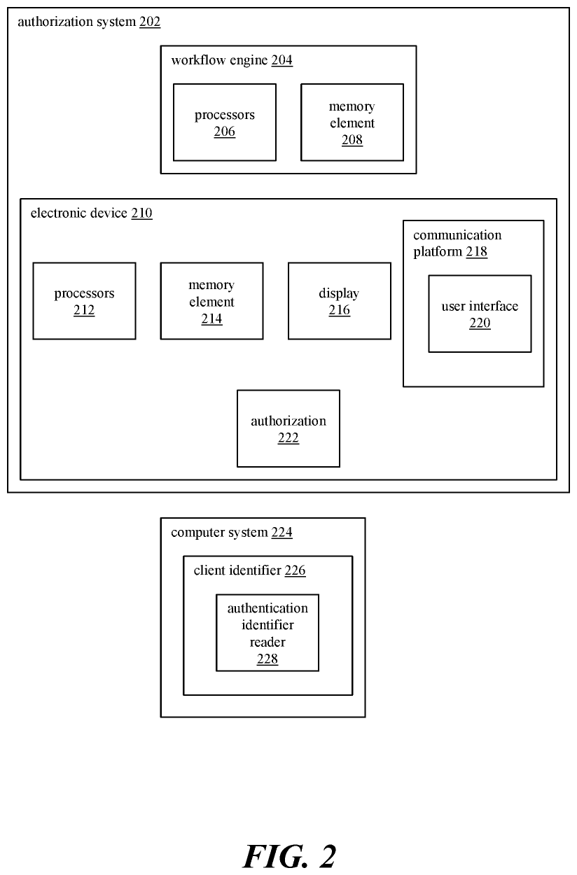

FIG. 2 is a block diagram that describes an authorization system 202, according to some embodiments of the present disclosure. In some embodiments, the authorization system 202 may include a workflow engine 204. The authorization system 202 may also include an electronic device 210, the electronic device 210 may be in communication with the workflow engine 204 over a network. The workflow engine 204 may include one or more processors 206. The workflow engine 204 may also include at least one memory element 208, the at least one memory element 208 configured to store instructions for controlling the one or more processors 206, the at least one memory element 208 retains one or more client identifiers associated with communication content.

In some embodiments, the electronic device 210 may include one or more processors 212, a display 216, and a communication platform 218. The electronic device 210 may also include at least one memory element 214, the at least one memory element 214 configured to store instructions for controlling the one or more processors 212. The electronic device 210 may also include an authorization 222 for access to the communication content of the communication platform 218 may be configured to be transmitted, by the electronic device 210, to the workflow engine 204.

In some embodiments, the communication platform 218 may also include a user interface 220, the communication platform 218 of the client device may be configured to receive the communication content by a computer system 224. Responsive to decryption, a decrypted client identifier may be configured to be validated, by the workflow engine 204, to authenticate the intended user. Authenticated decrypted communication content may be configured to be displayed on the display 216 of the electronic device 210 to the authenticated intended user.

In some embodiments, the computer system 224 may also include a client identifier 226 of the one or more client identifiers to identify an intended user at which the communication content may be created, the communication content may be configured to be generated by the computer system 224 and encrypted by the workflow engine 204. The client identifier 226 may also include an authentication identifier reader 228, the authentication identifier reader 228 may be configured to decrypt the client identifier 226 from the authentication image when the authentication identifier reader 228 identifies the authentication image. Responsive to encryption, encrypted communication content may be visually encoded as an authentication image, the authentication image may be displayed within the communication platform 218 of the electronic device 210.

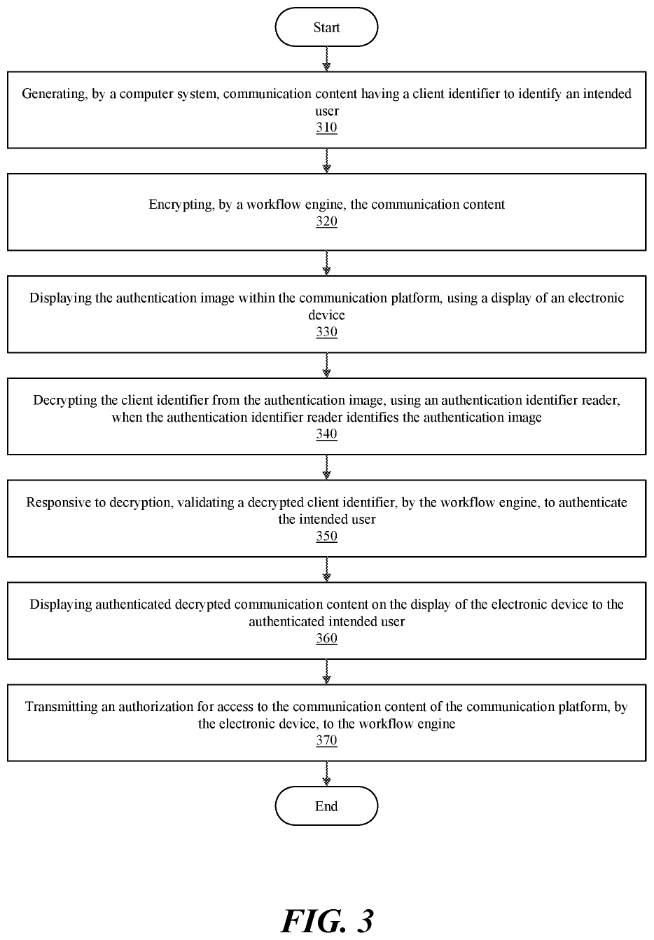

FIG. 3 is a flowchart that describes a method, according to some embodiments of the present disclosure. In some embodiments, at 310, the method may include generating, by a computer system, communication content having a client identifier to identify an intended user. At 320, the method may include encrypting, by a workflow engine, the communication content. At 330, the method may include displaying the authentication image within the communication platform, using a display of an electronic device. At 340, the method may include decrypting the client identifier from the authentication image, using an authentication identifier reader, when the authentication identifier reader identifies the authentication image.

In some embodiments, at 350, the method may include, responsive to decryption, validating a decrypted client identifier, by the workflow engine, to authenticate the intended user. At 360, the method may include displaying authenticated decrypted communication content on the display of the electronic device to the authenticated intended user. At 370, the method may include transmitting an authorization for access to the communication content of the communication platform, by the electronic device, to the workflow engine. Responsive to encryption, encrypted communication content may be visually encoded as an authentication image. In some embodiments, the method for data verification and approval in communication platforms. Altering, by the authenticated intended user, the authenticated decrypted communication content. In some embodiments, the method for data verification and approval in communication platforms.

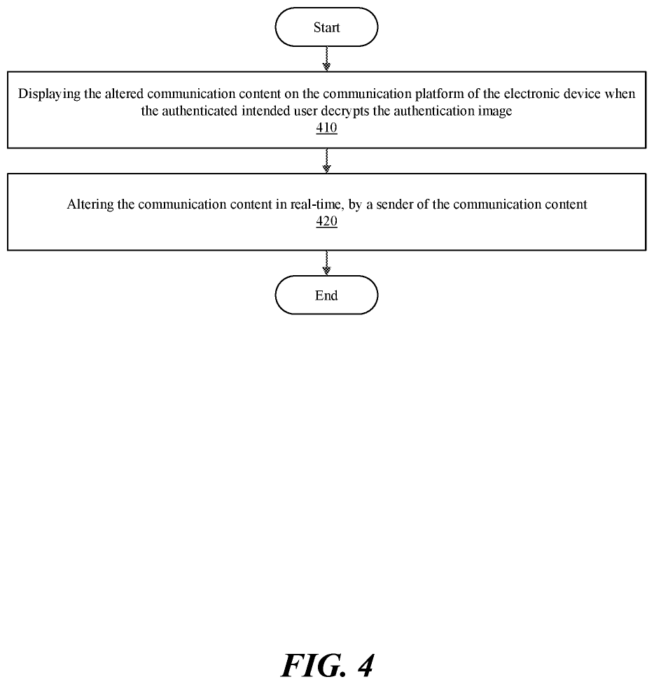

FIG. 4 is a flowchart that further describes the method from FIG. 3, according to some embodiments of the present disclosure. In some embodiments, the method for data verification and approval in communication platforms. At 410, the altering may include displaying the altered communication content on the communication platform of the electronic device when the authenticated intended user decrypts the authentication image. At 420, altering the communication content in real-time may be performed by a sender of the communication content.

### Additional Description

In an embodiment, using Cyphlens, a specialized acknowledgment receipt image may be generated and included in an email. Upon receiving it, the rightful recipient may actively confirm the opening of the email and review the content enclosed within the image by decrypting it using their Cyphlens app. This Cyphlens image may either be embedded directly within the email's body or attached as a file. The sender will then receive a notification or have access to a record indicating that the Cyphlens image has been accessed and confirmed as acknowledged by the rightful recipient(s). Moreover, as an alternative or supplement to the entire email, the Cyphlens image may be utilized to signify that a specific, distinct component of the email has been viewed (e.g., the cost of a product or a medical diagnosis).

In an embodiment using Cyphlens, a merchant or business may generate a tailored Cyphlens image to present a personalized, dynamic offer to a potential customer. This offer may be securely claimed (i.e., actioned) exclusively by the designated recipient(s), all without leaving the email client. The Cyphlens image may be directly embedded within the email's content or included as an attachment. Additionally, the merchant will receive a notification or have access to a log confirming that the Cyphlens image has been accessed and the offer has been viewed and claimed (or not claimed) by the potential customer in a seamless process. Offers created with Cyphlens are exclusively accessible and claimable by the intended recipient(s), rendering them resilient to competitive data collection. Others with access to such emails would be unable to decrypt them and discern the specifics of the offer or any applied discounts.

Furthermore, offers made using Cyphlens may be adaptable, allowing the merchant to adjust details in real-time (e.g., amounts, expiration dates) without the need for a new email. The user would decrypt the same Cyphlens image, now displaying the updated offer details. For instance, a retailer could send a Cyphlens image extending a special price of $19.99 to a specific user if the offer is claimed on the same day. However, if the user attempts to view and claim the offer the following day, the displayed price would be adjusted to $24.99. Finally, if the user tries to access the offer on the third day, it would have expired, and the user would not see any price or offer details. Examples of this application encompass acknowledging a meeting invitation, confirming the receipt of an email by a specified date, providing evidence of the delivery of other specific, distinct information that the sender requires the recipient to expressly acknowledge.

Using Cyphlens, the data slated for verification may be encrypted within a Cyphlens image. Users may then securely examine and validate this information via the Cyphlens app, all without exiting their email platform. For example, a bank could dispatch a Cyphlens image to its customers, encompassing their month-end balance. Only the designated recipient possesses the capability to access this information and subsequently confirm their agreement with the balance provided by the bank (i.e., verifying its accuracy).

With Cyphlens, the process of approving information occurs through the decryption of a Cyphlens image using the Cyphlens app. Specifically, the designated recipient(s) decrypts the Cyphlens image within the email, containing the encrypted information, and proceeds to confirm the approval with a swipe gesture, all within the Cyphlens app. No redirection or external platform login is necessary. For instance, an employee may seek approval from their manager for specific pricing to be offered to a potential client. Using the Cyphlens platform, the employee generates a Cyphlens image with the encrypted approval request and sends it via email to their manager. The manager, upon receiving the email, decrypts the Cyphlens image and provides their approval directly within the Cyphlens app. This approval process may be conducted individually (only the manager may decrypt and approve the request within the Cyphlens image) or as part of a larger approval group (multiple managers may decrypt and approve the request within the Cyphlens image), either sequentially or in parallel.

With Cyphlens, the website where the purchase was initiated (but not completed) may generate a Cyphlens image containing the user's shopping cart details, for instance. This encrypted Cyphlens image may be transmitted to the user via email (or another messaging platform) and may only be decrypted by the designated recipient. Upon receiving this email, the user may decrypt the Cyphlens image using their Cyphlens app, make any necessary updates to the items in the decrypted shopping cart (e.g., adjust quantities, remove items), and then choose to finalize the purchase by authorizing a payment transaction. All of these steps occur within the Cyphlens app and the user's email, without requiring redirection to any external website or platform.

In certain scenarios, completing the payment or authorization for a purchase may necessitate multiple approvals (e.g., company purchases may require approval from both an employee and the CFO). In such cases, all intended users may decrypt the Cyphlens image, and their authorization may occur either sequentially or simultaneously. Additionally, in specific situations, the vendor may mandate that payments be conducted via Cyphlens through email (or another messaging platform) to enhance the security of the payment process. For example, a customer visits an online retailer's website, adds items to their shopping cart, but then abandons the purchase. The retailer could subsequently send the user a Cyphlens image containing encrypted information, including the shopping cart items and the total amount due, and request an authorization to finalize the purchase. The user could then access their shopping cart and complete the payment directly from their email using their Cyphlens app. Another scenario could involve the purchase of a flight ticket, where the final payment could occur at a later time or in real-time (for added security) through the customer's email and Cyphlens, following a similar process as described above.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An authorization system for data verification and approval in communication platforms, comprising:
a workflow engine comprising:
one or more processors; and
at least one memory element, the at least one memory element configured to store instructions for controlling the one or more processors, the at least one memory element retains one or more client identifiers associated with communication content;
a client device, the client device is in communication with the workflow engine over a network, the client device, comprising:
one or more processors;
at least one memory element, the at least one memory element configured to store instructions for controlling the one or more processors;
a display; and
a communication platform having a user interface, the communication platform of the client device is configured to receive the communication content by a computer system, the computer system having a client identifier of the one or more client identifiers to identify an intended user at which the communication content is created, the communication content is configured to be generated by the computer system and encrypted by the workflow engine, and wherein
responsive to encryption, encrypted communication content is visually encoded as an authentication image, the authentication image is displayed within the communication platform of the client device; and
an electronic device, the electronic device is in communication with the workflow engine over the network, the electronic device, comprising:
a display having a graphical user interface;
one or more processors;
at least one memory element, the at least one memory element stores the client identifier of the computer system; and
an authentication identifier reader, the authentication identifier reader is configured to decrypt the client identifier from the authentication image when the authentication identifier reader identifies the authentication image, wherein
responsive to decryption, a decrypted client identifier is configured to be validated, by the workflow engine, to authenticate the intended user, and wherein
authenticated decrypted communication content is configured to be displayed on the display of the client device to the authenticated intended user, and
an authorization for access to the communication content of the communication platform is configured to be transmitted, by the electronic device, to the workflow engine.

2. The authorization system for data verification and approval in communication platforms of claim 1, wherein the authentication image is configured to indicate to a sender of the communication content, when at least a portion of the communication content has been accessed by the authenticated intended user.

3. The authorization system for data verification and approval in communication platforms of claim 1, wherein the communication content is configured to be altered in real-time by a sender of the communication content.

4. The authorization system for data verification and approval in communication platforms of claim 3, wherein the altered communication content is configured to be displayed on the communication platform of the client device when the authenticated intended user decrypts the authentication image.

5. The authorization system for data verification and approval in communication platforms of claim 1, wherein the authentication image is a visual representation of the encrypted communication content.

6. The authorization system for data verification and approval in communication platforms of claim 1, wherein the electronic device having a camera, the camera is configured to capture the authentication image of the display of the client device.

7. The authorization system for data verification and approval in communication platforms of claim 1, wherein the authentication image of the display of the client device is uploaded to the electronic device.

8. The authorization system for data verification and approval in communication platforms of claim 1, wherein the client identifier is at least one of a username, an email address, phone number, or a name of a user.

9. The authorization system for data verification and approval in communication platforms of claim 1, wherein the electronic device having an input sensor disposed on the display of the electronic device, the input sensor is configured to sense an external input to submit the authorization for access to the communication content to the workflow engine.

10. The authorization system for data verification and approval in communication platforms of claim 1, wherein the authorization for the access to the communication content is transmitted to the workflow engine when the client identifier of the electronic device matches the client identifier associated with communication content of the workflow engine.

11. The authorization system for data verification and approval in communication platforms of claim 1, wherein the authenticated decrypted communication content is configured to be altered by the authenticated intended user.

12. The authorization system for data verification and approval in communication platforms of claim 1, wherein the authenticated decrypted communication content is configured to be authorized sequentially by one or more authenticated intended users.

13. The authorization system for data verification and approval in communication platforms of claim 1, wherein the authenticated decrypted communication content is configured to be authorized in parallel by one or more authenticated intended users.

14. The authorization system for data verification and approval in communication platforms of claim 1, further comprising a financial transaction system, the financial transaction system in communication with the workflow engine and the authenticated decrypted communication content, and wherein the authenticated decrypted communication content being a payment request.

15. The authorization system for data verification and approval in communication platforms of claim 14, wherein the authenticated decrypted communication content is configured to be altered by the authenticated intended user.

16. An authorization system for data verification and approval in communication platforms, comprising:
a workflow engine comprising:
one or more processors; and
at least one memory element, the at least one memory element configured to store instructions for controlling the one or more processors, the at least one memory element retains one or more client identifiers associated with communication content; and
an electronic device, the electronic device is in communication with the workflow engine over a network, the electronic device, comprising:
one or more processors;
at least one memory element, the at least one memory element configured to store instructions for controlling the one or more processors;
a display; and
a communication platform having a user interface, the communication platform of the client device is configured to receive the communication content by a computer system, the computer system having a client identifier of the one or more client identifiers to identify an intended user at which the communication content is created, the communication content is configured to be generated by the computer system and encrypted by the workflow engine, and wherein
responsive to encryption, encrypted communication content is visually encoded as an authentication image, the authentication image is displayed within the communication platform of the electronic device; and
an authentication identifier reader, the authentication identifier reader is configured to decrypt the client identifier from the authentication image when the authentication identifier reader identifies the authentication image, and wherein
responsive to decryption, a decrypted client identifier is configured to be validated, by the workflow engine, to authenticate the intended user, and wherein
authenticated decrypted communication content is configured to be displayed on the display of the electronic device to the authenticated intended user, and
an authorization for access to the communication content of the communication platform is configured to be transmitted, by the electronic device, to the workflow engine.

17. A method for data verification and approval in communication platforms, comprising:
generating, by a computer system, communication content having a client identifier to identify an intended user;
encrypting, by a workflow engine, the communication content;
responsive to encryption, encrypted communication content is visually encoded as an authentication image;
displaying the authentication image within the communication platform, using a display of an electronic device;
decrypting the client identifier from the authentication image, using an authentication identifier reader, when the authentication identifier reader identifies the authentication image,
responsive to decryption, validating a decrypted client identifier, by the workflow engine, to authenticate the intended user,
displaying authenticated decrypted communication content on the display of the electronic device to the authenticated intended user; and
transmitting an authorization for access to the communication content of the communication platform, by the electronic device, to the workflow engine.

18. The method for data verification and approval in communication platforms of claim 17, further comprising altering, by the authenticated intended user, the authenticated decrypted communication content.

19. The method for data verification and approval in communication platforms of claim 17, further comprising altering the communication content in real-time, by a sender of the communication content, and wherein
displaying the altered communication content on the communication platform of the electronic device when the authenticated intended user decrypts the authentication image.

20. The method for data verification and approval in communication platforms of claim 17, further comprising transmitting the authorization for the access to the communication content to the workflow engine when the client identifier of the electronic device matches the client identifier associated with the communication content of the workflow engine.
